(19) United States
(12) Patent Application Publication
(10) Pub. No.: US 2014/0380379 A1
(43) Pub. Date: Dec. 25, 2014

(54) SYSTEMS AND METHODS FOR PERFORMING MEDIA ASSET RECORDINGS BASED ON POWER CONSUMPTION

(71) Applicant: United Video Properties, Inc., Santa Clara, CA (US)

(72) Inventors: Walter R. Klappert, Los Angeles, CA (US); Jeffrey N. Berenson, Nashua, NH (US); Paul G. Jensen, Menlo Park, CA (US)

(21) Appl. No.: 13/921,324

(22) Filed: Jun. 19, 2013

(51) Int. Cl. H04N 21/443; H04N 21/4147; H04N 21/482; H04N 21/472; H04N 21/433

(52) U.S. Cl. CPC H04N 21/4436; H04N 21/47214; H04N 21/4334; H04N 21/482; H04N 21/4147
USPC 725/58

(57) ABSTRACT

Systems and methods for performing cost efficient media asset recording on a user equipment device are provided. A first instance of a media asset is identified for recording. A media asset schedule database is searched to identify a second instance of the media asset. A determination, based on cost of power consumption information, is made as to whether recording the first instance of the media asset will cost less than recording the second instance of the media asset. Either the first instance of the media asset or the second instance of the media asset is selected for recording based on the determination.

### BACKGROUND

As media equipment devices, such as set-top boxes (STBs), have become ubiquitous fixtures in many homes, concerns have arisen over the cost of energy consumed by these devices. One reason for the high energy consumption by STBs is the cost of operating resources (e.g., a digital video recorder, digital processing circuitry, etc.) required to record media. Traditional systems lack an effective mechanism to record media in a cost efficient manner.

### SUMMARY

In view of the foregoing, systems and methods for performing media asset recordings based on power consumption are provided. In particular, systems and methods for recording a media asset at a lower power consumption cost are provided.

In some embodiments, a first media asset may be selected for recording. A search may be performed to determine whether a second media asset having substantially the same content (e.g., plot segments) is available. The second media asset may be scheduled for transmission from the same or different content source as the first media asset at the same or different time. A determination of power consumption cost (e.g., monetary value or power consumption amount) associated with recording the first asset and the second media asset is made. In some implementations, the cost for consuming power during a first period of the day (e.g., between 5-9 PM) may be higher than the cost for consuming power during a second period of the day (e.g., between 9 PM-5 AM). Based on this difference, when the second media asset is scheduled for transmission during the second period and the first media asset is scheduled for transmission during the first period, the system may determine that recording the second media asset will cost less than recording the first media asset. In some implementations, the cost for recording content in one version or format (e.g., high definition) may be higher than the cost for recording content in a second version or format (e.g., standard definition). Based on this difference, when the second media asset is in the second version or format and the first media asset is in the first version or format, the system may determine that recording the second media asset will cost less than recording the first media asset.

In response to determining that recording the second media asset will cost less than recoding the first media asset, the second media asset is automatically scheduled for recording instead of the first media asset. In some implementations, a user may be alerted or informed that recording the second media asset will cost less than recording the first media asset. In such circumstances, the second media asset may be scheduled for recording instead of the first media asset in response to receiving confirmation from the user responsive to the alert being provided to the user.

In some embodiments, a first instance of a media asset is identified for recording. The first instance may be automatically identified for recording (e.g., based on a user profile or as being part of a previously scheduled series recording). The first instance may be specifically selected by the user (e.g., by selecting a program listing from a grid or overlay). A media asset schedule database may be

searched to identify a second instance of the media asset. The second instance of the media asset may include identical subject matter or plot segments as the first instance. The second instance may be an identical copy of the first instance of the media asset but may be received from a different content source and/or at a different transmission time. A determination, based on cost of power consumption information, is made as to whether recording the first instance of the media asset will cost less than recording the second instance of the media asset. The cost of recording the first and second instance may be a monetary value (e.g., in dollars) or a power consumption amount (e.g., in kilowatts) based on the resources needed to record each instance.

In some embodiments, an identifier of a utility entity associated with the user equipment device may be transmitted to a server. The cost of power consumption information associated with the utility entity may be received from the server based on the identifier. In some implementations, the cost of power consumption information received from the server may be used to populate or generate a database of power consumption cost. In some implementations, the cost of power consumption information may be received from the user and used to populate or generate a database of power consumption cost. In some implementations, the database that indicates a given time period and the associated power consumption cost may be cross-referenced to determine the cost associated with consuming power during each respective transmission time of the first and second instances of the media asset. In some implementations, resources (e.g., decoder circuitry, tuner, recording device, etc.) needed to record each instance of the media asset may be identified to determine the power consumption amount associated with recording the first and second instances of the media asset.

In some implementations, the first instance of the media asset is a higher definition version of the media asset than the second instance. In such cases, the cost of power consumption information may indicate that recording the higher definition version of the media asset consumes more power than recording a lower definition version of the media asset. As such, it may be determined that recording the first instance of the media asset will not cost less than recording the second instance of the media asset based on the definition of the media asset.

Either the first instance of the media asset or the second instance of the media asset is selected for recording based on the determination. In some implementations, the second instance of the media asset is selected for recording instead of the first instance of the media asset when recording the second instance of the media asset is determined to cost less than recording the first instance of the media asset. In some embodiments, the user equipment device may be switched from a first power mode to a second power mode to record the selected first instance of the media asset or the second instance of the media asset, the second power mode may consume more power than the first power mode.

In some implementations, power consumption cost priorities assigned to each media asset instance may be processed to determine whether to record one instance or the other regardless of the cost of power consumption. In some implementations, an option may be generated for display to perform power efficient recording. The selection of either the first instance of the media asset or the second instance of the media asset for recording may be performed in response to receiving a user selection of the option. The option may include an indication to always perform recording in the most cost efficient manner (e.g., at the lowest cost). Receiving a user selection of the option to always perform recording in the most cost efficient manner may override any previously assigned power consumption cost priorities.

### BRIEF DESCRIPTION OF THE DRAWINGS

The above and other features of the present disclosure, its nature and various advantages will be more apparent upon consideration of the following detailed description, taken in conjunction with the accompanying drawings, and in which:

FIG. 1 is a diagram of an interactive grid display in accordance with some embodiments of the disclosure;

FIG. 2 is a diagram of an interactive media system in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is diagram of a display for performing cost-efficient media asset recordings in accordance with some embodiments of the disclosure;

FIG. 6 is an exemplary data structure of energy consumption costs in accordance with some embodiments of the disclosure; and

FIG. 7 is a flow diagram of the illustrative steps involved in performing cost-efficient media asset recordings in accordance with some embodiments of the disclosure.

### DETAILED DESCRIPTION

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a set-top box, television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a website), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

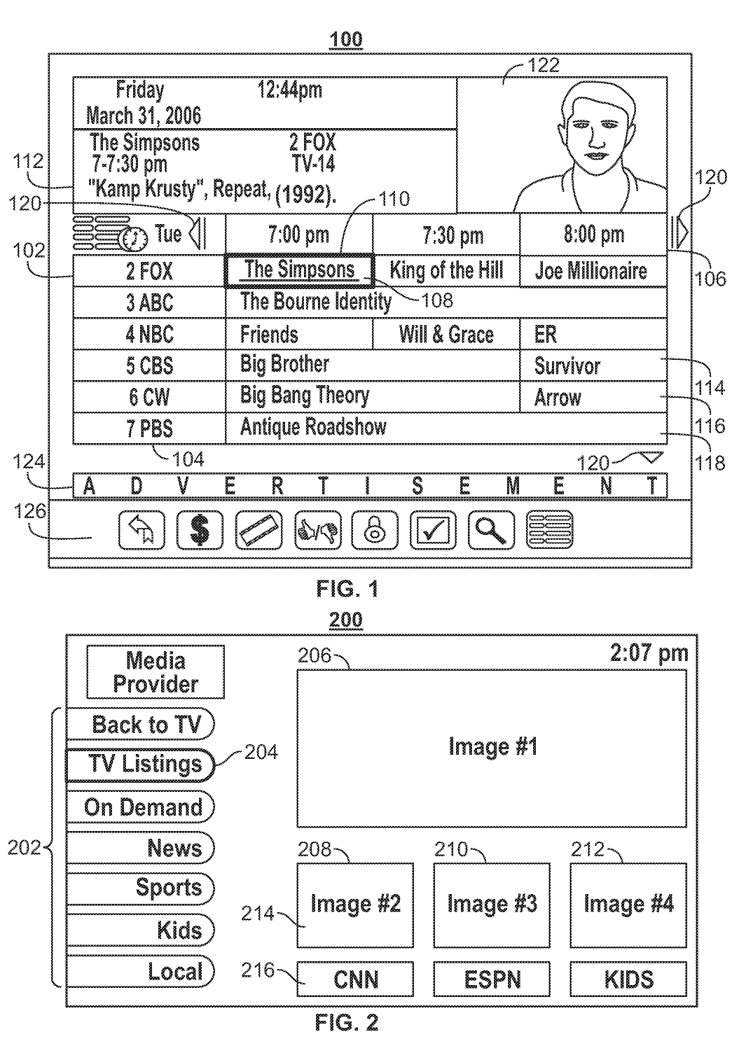

FIGS. 1-2 show illustrative display screens that may be used to provide media guidance data. The display screens shown in FIGS. 1-2 and 5 may be implemented on any suitable user equipment device or platform. While the displays of FIGS. 1-2 and 5 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by genre (e.g., movies, sports, news, children, or other genres of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet website or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, recording a program at a lowest power consumption cost, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

As referred to herein, the phrase “power consumption cost” should be understood to mean the monetary cost of consuming power (e.g., how much money based on the price per kilowatt hour (kHr) the user would have to pay for the user's equipment to perform the requested action (recording)) or the amount of power consumed (e.g., the amount of kilowatts that would be consumed by the user's equipment in performing the requested action (recording)).

In some embodiments, a user may schedule a recording of a media asset by selecting a corresponding media asset listing from grid 102. In response to receiving a user selection of the media asset listing, control circuitry 304 may request the user to select a setting (recording or reminder) for the corresponding media asset. For example, control circuitry 304 may request the user to select whether the corresponding media asset is to be scheduled for recording. In some implementations, the user may instruct control circuitry 304 to schedule only the selected media asset for recording. In some implementations, where the media asset is an episode in a series, the user may instruct control circuitry 304 to schedule all of the episodes of the series for recording in response to selecting a given option. In some embodiments, the media assets may be automatically scheduled for recording based on a determination that the media assets match a user profile.

In some embodiments, selection of the media asset for recording may include a user selection of an option to record the media asset at the lowest power consumption cost. For example, control circuitry 304 may receive user input instructing control circuitry 304 to search for another instance of the media asset (e.g., another instance of the show “Family Guy” that is scheduled for recording at 7 PM) and if found, determine whether that instance will consume less power or will have a lower power consumption cost. In response to determining that the other instance that is found will consume less power or will have a lower power consumption cost, then control circuitry 304 will schedule for recording the other instance (e.g., the instance of the show “Family Guy” scheduled for transmission at 1 AM) instead of the user selected instance of the media asset (e.g., the instance of the show “Family Guy” scheduled for transmission at 7 PM).

As part of setting up the recording, the user may assign a power consumption cost priority (e.g., high, medium, low) to the given media asset or to a category or types of media assets (e.g., comedies, dramas, high definition, standard definition, etc.). This priority may be used by control circuitry 304 to resolve recording conflicts, determine which programs to delete, or determine whether to schedule the media asset for recording at the lowest power consumption cost or not. For example, before searching for another instance to determine whether another instance is available to record the media asset at a lower power consumption or cost, control circuitry 304 may determine whether the priority assigned to the media asset (directly or through the associated characteristic) allows the other instance to be recorded in place of the requested media asset. If the priority assigned allows the other instance to be recorded, then control circuitry 304 may search for the other instance and schedule the other instance if the cost or power consumption associated with recording the other instance is lower than that associated with recording the requested media asset instance. Systems and methods for assigning recording priorities are discussed in more detail in Ellis et al. U.S. Pat. No. 8,457,475, issued on Jun. 4, 2013, which is incorporated by reference herein in its entirety.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), power consumption cost preferences, parental control settings for settings adjustments (modifying program recordings), customized presentation of Internet content (e.g., presentation of social media content, e-mail, electronically delivered articles, etc.) and other desired customizations.

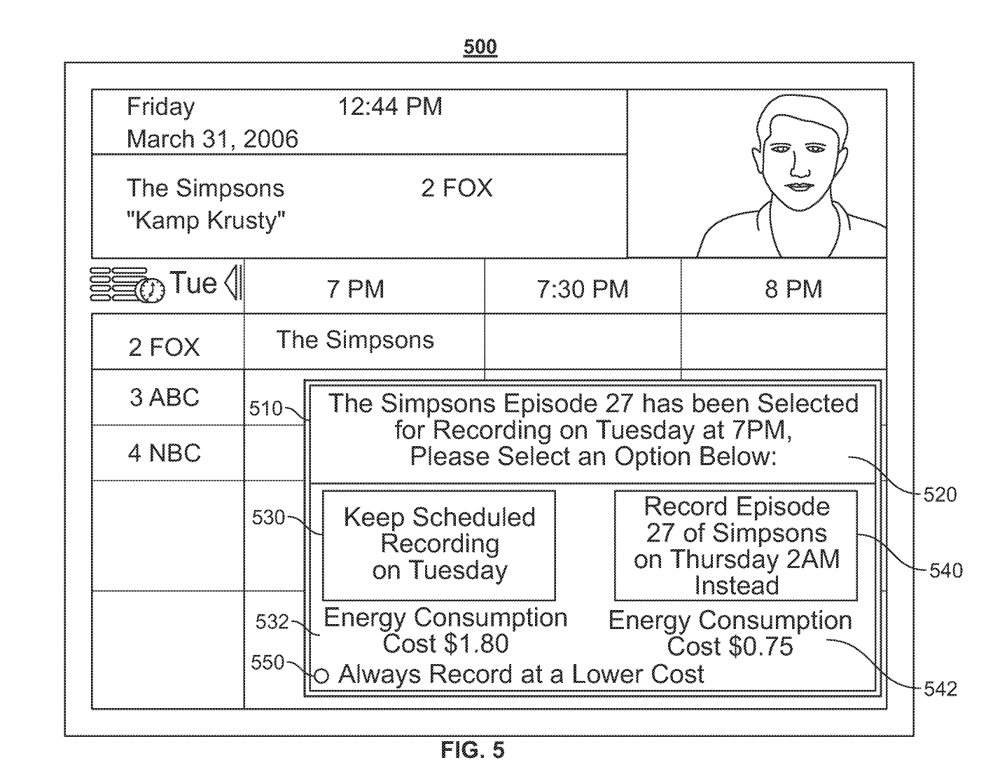

The media guidance application may allow a user to provide user profile information or may automatically compile user profile information. The media guidance application may, for example, monitor the content the user accesses and/or other interactions the user may have with the guidance application. For example, the media guidance application may modify user preferences for power consumption costs based on always record at lower cost option 550 being selected in FIG. 5. Additionally, the media guidance application may obtain all or part of other user profiles that are related to a particular user (e.g., from other websites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

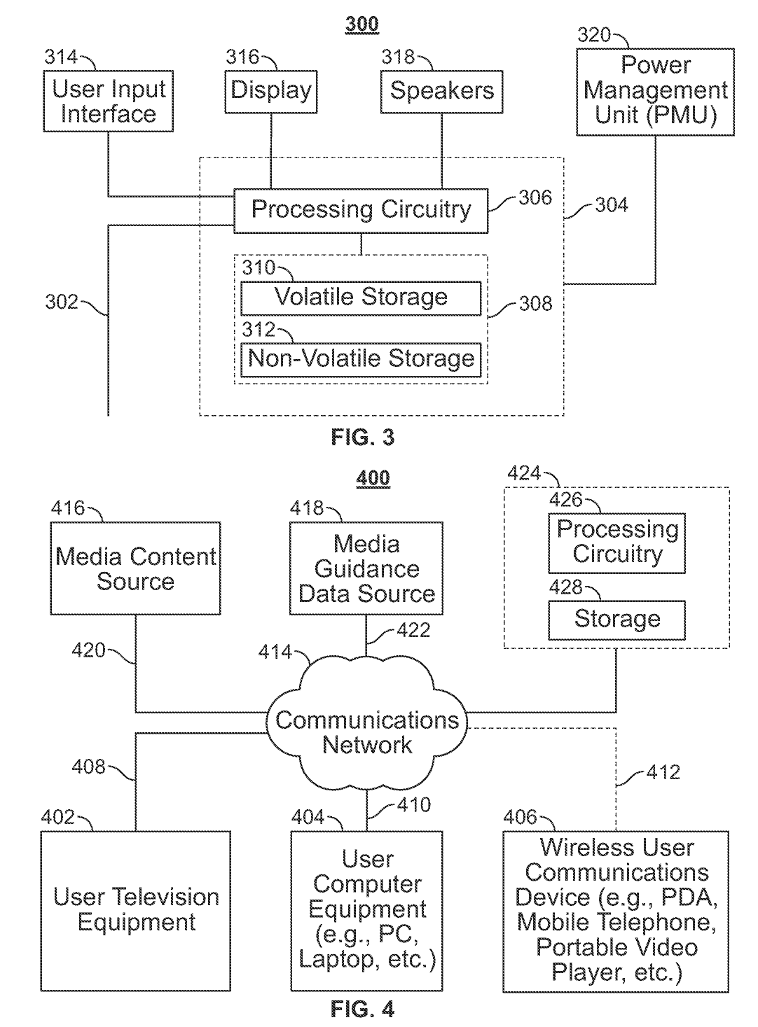

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers, such as remote server 424. As referred to herein, “remote server”, “server”, “guidance application server”, “media server”, or any other type of server may be understood to mean any server or device that is remote to user equipment device 300 and communicates with user equipment device 300 over communication network 414. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

In some embodiments, control circuitry 304 is configured to receive updates to media information stored in storage 308 of user equipment device 300. The user equipment device 300 may be a media equipment device. As referred to herein, “update”, “update information”, “update to media information”, “media update”, and “update to media” should all be understood to mean a piece of software or information received by control circuitry 304 at user equipment device 300 that is intended to replace, supplement, or modify all or portions of media information stored in storage 308, after which the media information is made more current or complete.

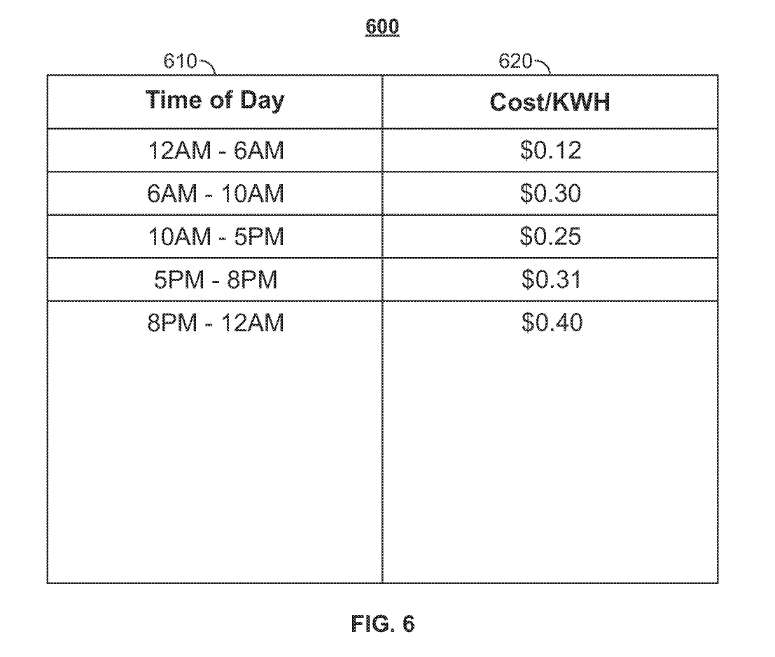

A power management unit (PMU) 320 may include some or all of the same or similar circuitry as control circuitry 304. PMU 320 may include hardware and/or software for controlling a power mode of user equipment device 300. PMU 320 may also determine the cost of power consumption for performing different functions with user equipment device 300. In some implementations, PMU 320 may have a database 600 of power consumption costs (e.g., FIG. 6). Database 600 may include a cost associated with consuming power at different times of the day (e.g., morning, afternoon, evening or specific hours). Specifically, time of day field 610 may represent a given time period in the day and cost field 620 may indicate the cost (monetary value) of consuming power at the time specified in field 610. PMU 320 may determine a cost of power consumption based on the type of hardware or operations needed to perform a given operation. For example, PMU 320 may determine that consuming (e.g., recording/accessing) a media asset in high resolution (e.g., HD format) may consume greater resources resulting in greater power consumption than consuming a media asset in low resolution (e.g., SD format).

In some embodiments, database 600 may be manually populated by a user. For example, the user may input into fields 610 a time of day and into fields 620 the cost for consuming power during the corresponding time of day specified in field 610. Although the cost shown in field 620 is a monetary value, any other type of indication as to cost may be provided. For example, fields 620 may include a relative cost indication of high, medium and low. For example, it may be known that consuming power during a given time (afternoon) of day costs more than another time of day (middle of the night). Accordingly, field 620 for one time period (e.g., between 12 AM-6 AM) may indicate the cost to be “low” whereas field 620 for another time period (e.g., between 10 AM-5 PM) may indicate the cost to be “high”. These relative costs may be entered by the user or automatically populated based on received data (e.g., populated automatically based on information received from a media guidance data source).

In some embodiments, control circuitry 304 may instruct power management unit (PMU) 320 to switch user equipment device 300 from a first power mode of operation to a second power mode of operation. Alternatively, PMU 320 may receive instructions to perform the switching directly over communications network 414. For example, remote server 424 may send PMU 320 a message telling it to switch user equipment device 300 from a first power mode to a second power mode.

As referred to herein, a first power mode may be a low power mode of operation. A first power mode may be understood to be a sleep mode, a standby mode, a power-off mode, a dormant mode, non-recording mode, or a low-power mode. A low-power mode may refer to a mode of operation wherein user equipment device 300 has sufficient power to perform basic computation or content consumption (e.g., compute whether an update should be performed or access a media asset) using processing circuitry 306 but insufficient power to perform more power-intensive tasks such as communicate with remote devices 424 over communications network 414 or record content. As referred to herein, a second power mode may be a high power mode of operation. A second power mode may be understood to be an awake mode, an active mode, a full-power mode, a high-power mode, or an update mode, where a device operating at a second power mode has sufficient power to perform an update to media information and perform a recording. On the other hand, a device operating at a first power mode may not have enough power to perform a recording and therefore may need to be switched to a second power mode to record a media asset. A device operating at a second power mode may consume more power than at a first power mode. In some embodiments, device 300 may operate at a third power mode, wherein the power consumed at the third power mode is greater than that consumed at the first power mode but less than that consumed at the second power mode. A third power mode may be an update mode, wherein device 300 operates at enough power to perform updates but not at full-power mode to transmit program information for a user to view. A third power mode may also refer to a low-power mode, as described above. All three modes of operation (e.g., first power mode, second power mode, third power mode) may be used interchangeably within the present disclosure.

In some embodiments, control circuitry 304 may schedule a first or second instance of the media asset for recording based on whether the device is operating in the first power mode or second power mode. Specifically, control circuitry 304 may disregard the power consumption cost associated with recording the first or second media asset and may automatically start recording the first or second instance of the media asset if the device is operating in the first power mode (e.g., the high power mode or a mode having sufficient power to perform the recording) at the time the first or second media asset is being received. In some implementations, the second instance of the media asset may be scheduled for recording instead of the first instance of the media asset because the power consumption cost of the second instance of the media asset is lower). However, if the device is determined to be operating in the first power mode (e.g., because the device is being updated or used) at the time the first media asset is being received or transmitted, control circuitry 304 may begin recording the first instance of the media asset and unscheduled the recording of the second instance of the media asset.

Once user equipment device 300 is switched to a second power mode of operation, control circuitry 304 may perform a scheduled recording of a media asset. As referred to herein, switching refers to activating a component of circuitry within user equipment device 300 that corresponds to a desired power mode of operation. Switching may be performed by PMU 320 to switch user equipment device 300 from a first power mode to a second power mode. A first power mode may correspond to a first circuitry component, and a second power mode may correspond to a second circuitry component. As referred to herein, switching from a first power mode to a second power mode involves deactivating the first circuitry component and activating a second circuitry component.

PMU 320 monitors and manages the power consumption of user equipment device 300. PMU 320 may be configured to monitor the current level of power consumption of user equipment device 300 based on device characteristics such as, but are not limited to, battery usage information, screen brightness, screen saver settings, central processing unit (CPU) power usage, graphic processing unit (GPU) power usage, integrated processor power usage, number of applications currently running on user equipment device 300, number and frequency of recordings scheduled to be performed on user equipment device 300, and the current power mode of operation (e.g., first power mode, second power mode). More specifically, PMU 320 monitors the power state of user equipment device 300 to determine when device 300 switches from a first power mode to a second power mode. In some embodiments, PMU 320 may reside on user equipment device 300 as a component of control circuitry 304. In other embodiments, PMU 320 may be a unit that is external to user equipment device 300. In these cases, PMU 320 may communicate with user equipment device 300 by sending and receiving instructions from control circuitry 304. In some embodiments, PMU 320 may be a cloud computing component (e.g., may be incorporated or be associated with remote storages 428) and may communicate with control circuitry 304 via the Internet or other communications path to provide power consumption cost related information associated with the different media asset instances.

PMU 320 may perform the switching in response to various conditions, based on instructions from control circuitry 304. In some embodiments, control circuitry 304 determines whether the switching should be performed by comparing a power consumption cost for performing a recording at a first time (e.g., during the afternoon) to a power consumption cost for performing a recording at a second time (e.g., during the night). If the cost for performing the recording at the second time is less than the cost for performing the recording at the first time, control circuitry 304 may instruct PMU 320 to switch user equipment device 300 from a first power mode to a second power mode at the second time instead of the first time. In some embodiments, control circuitry 304 determines whether the switching should be performed by comparing a power consumption cost for performing a recording of a high definition version of a media asset (e.g., an HD version) to a power consumption cost for performing a recording of a lower definition version of a media asset (e.g., an SD version). If the cost for performing the recording of the lower definition version is less than the cost for performing the recording of the high definition version of the media asset, control circuitry 304 may schedule the recording of the lower definition version of the media asset instead of the higher definition version and instruct PMU 320 to activate only the appropriate circuitry needed to perform the recording of the lower definition version of the media asset.

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above.

Storage 308 may include volatile storage 310 and nonvolatile storage 312. Nonvolatile storage 312 may be used to launch a boot-up routine and other instructions. Cloud-based storage, described in relation to FIG. 4, may be used to supplement storage 308 or instead of storage 308.

In some embodiments, control circuitry 304 may store media information in volatile storage 310 when user equipment device 300 is in a second power mode. This is because storage 308 may not include a hard disk or sufficient nonvolatile memory to store the entire set of media information obtained by user equipment device 300. Even when storage 308 includes nonvolatile storage 312, storing certain types of media information or copies of that media information (e.g., program schedule information) in volatile storage 310 may be desirable because the information may be retrieved faster than data stored in nonvolatile storage 312. However, the disadvantage of storing media information in volatile storage 310 is that the stored information will be lost when user equipment device 300 shuts down and no longer has power. In such cases, control circuitry 304 may instruct all or portions of media information stored in volatile storage 310 to be stored in nonvolatile storage 312. These instructions to transfer information from volatile to nonvolatile storage may be triggered by communication from PMU 320 to control circuitry 304. In some embodiments, PMU 320 monitors the power consumption level of user equipment device 300 and communicates with control circuitry 304 when the battery level of user equipment device 300 is low or before switching user equipment device 300 to power-off mode.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 318. User input interface 318 may be any suitable user interface, such as a remote control, mouse, trackball, keypad, keyboard, touch screen, touchpad, stylus input, joystick, voice recognition interface, electroencephalography (EEG) interface, or other user input interfaces. User input interface 318 may be configured to receive preferences from a user of user equipment device 300. These preferences may include power consumption cost preferences. Power consumption cost preferences refer to the user's preferences for whether costs savings should be considered when performing a recording. For example, a user may set a power consumption cost preference indicating that a media asset should always be recorded at the lowest power consumption cost possible. In some implementations, a user may set a power consumption cost preference indicating that only media assets having a low or high priority level should be recorded at the lowest power consumption cost possible. In such circumstances, a media asset having a low priority level may always be recorded at the lowest power consumption cost possible while another media asset having a higher priority level may be recorded regardless or independent of the power consumption cost for recording the media asset. The priorities may be manually set by the user or automatically assigned based on a user profile. These preferences may be presented to the user on display 315 and input may be received from the user modifying the power consumption cost preferences.

Display 316 may be provided as a stand-alone device or integrated with other elements of user equipment device 300. Display 316 may be one or more of a monitor, a television, a liquid crystal display (LCD) for a mobile device, or any other suitable equipment for displaying visual images. In some embodiments, display 316 may be HDTV-capable. In some embodiments, display 316 may be a 3D display, and the interactive media guidance application and any suitable content may be displayed in 3D. A video card or graphics card may generate the output to the display 316. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 318 may be provided as integrated with other elements of user equipment device 300 or may be stand-alone units. The audio component of videos and other content displayed on display 316 may be played through speakers 318. In some embodiments, the audio may be distributed to a receiver (not shown), which processes and outputs the audio via speakers 318.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a website accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the website www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412. Media guidance data source 418 may communicate with remote server 424 over communication network 414.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

Media guidance data source 418 may also send updates to one or more user equipment devices 402, 404, and 406 over communications network 414 to update media information in their storage 308. These updates may include, but are not limited to, updates to schedules for the media information, updates to metadata associated with media, and scheduled recordings of media. In some embodiments, media guidance data source 418 may send updates periodically based on a time schedule (e.g., once a week, once a day, once every 12 hours, etc.).

Media guidance data source 418 may also send power consumption cost information to one or more user equipment devices 402, 404, and 406 over communications network 414 to update power consumption information in their respective storage 308 (or database 600). These updates may include, but are not limited to, power consumption cost at different times in the day for different utility entities, power consumption cost for operating different components of user equipment device 300, etc. In some embodiments, media guidance data source 418 may send updates periodically based on a time schedule (e.g., once a week, once a day, once every 12 hours, etc.).

Media guidance data source 418 may also send updates in response to receiving a request from user equipment devices 402, 404, and/or 406 for an update. In some instances, these requests for an update may be initiated when media information has been lost or damaged in storage 308 of the user equipment device. In other instances, these requests may be initiated when the media information stored in storage 308 is running low (e.g., the stored media information is only applicable for one more day). In another instance, these requests may also be initiated if storage space in storage 308 increases. The requests may also be initiated by user equipment devices 402, 404, and/or 406 based on an update schedule determined by PMU 320 on the device. For example, PMU 320 may instruct control circuitry 304 to request an update to media information or power consumption information some time before performing a recording operation or other content consumption operation. In some implementations, media guidance data source 418 may transmit the updates in response to receiving updated power consumption cost information from a given utility entity.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In other embodiments, media guidance data source 418 may send media guidance data to one or more remote servers 424, which may or may not reside on a cloud network. Guidance data may include user information related to the data. For example, guidance data may include viewing information of a particular media asset, content source, or categories of media. Guidance data may also include user preference information for media which correspond to one or more users. Media guidance data source 418 may send these guidance data to one or more remote servers 424 over communications network 414 to be stored in one or more remote storages 428.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server 424. For example, media guidance applications may be implemented partially as a client application on control circuitry 304 of user equipment device 300 and partially on a remote server 424 as a server application (e.g., media guidance data source 418) running on control circuitry of the remote server 424. When executed by control circuitry of the remote server 424 (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

In some embodiments, media guidance system 400 may also include a remote server 424 which communicates over communications network 414 with one or more user equipment devices 402, 404, and 406. Remote server 424 has its own processing circuitry 426 and storage 428.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

In some embodiments, a user may schedule a recording of a first instance of a media asset. Control circuitry 304 may search for a second instance of the media asset. In response to identifying a second instance of the media asset, control circuitry 304 may determine whether recording the first instance or recording the second instance will consume less power or whether the cost of power consumption for recording the first instance is less than recording the second instance. Control circuitry 304 may adjust the scheduled recording of the media asset to consume less power or to result in a lower cost of power consumption for performing the recording. Although this disclosure is discussed in terms of scheduled recordings, the teachings apply to any type of setting or action that can be performed at a reduced cost or lower power consumption (e.g., reminders, transfers to secondary storage, etc.).

As referred to herein, each “instance” of a media asset should be understood to mean another copy of the media asset that has substantially identical content portions. Specifically, one instance of a media asset may be a copy of the media asset transmitted at one point in time (e.g., between 7-8 PM) and another instance of the media asset may be an identical copy of the media asset that is transmitted at another point in time (e.g., between 10-11 PM). The second instance of the media asset may be in a different format (e.g., a standard definition format) than the first instance (e.g., which may be in high definition format) but will still include substantially the same content portions as the first media asset. The second instance may have different commercial or advertising breaks or may have no commercials or advertising breaks at all whereas the first instance does but both have identical content portions. The second instance may be received from a different source than the first instance.

In some embodiments, when the first instance of the media asset has more commercials or advertising breaks than the second instance, the first instance may have a longer run-length than the second instance. In such circumstances, PMU 320 may determine that the power consumption cost associated with recording the first instance may be higher than the power consumption cost associated with recording the second instance. Accordingly, control circuitry 304 may schedule the second instance for recording instead of the first instance.

FIG. 5 is a diagram of a display 500 for performing cost-efficient media asset recordings in accordance with some embodiments of the disclosure. Display 500 may be generated by control circuitry 304 in response to identifying another instance of a media asset that has been scheduled for recording (e.g., either automatically scheduled or selected for recording by a user). For example, control circuitry 304 may monitor media assets scheduled for recording. Control circuitry 304 may, for each media asset scheduled for recording, search a media asset information source for another instance of the media asset.

In some implementations, the media asset information source may include a local or remote database of media asset schedule information. In particular, control circuitry 304 may determine from the media asset schedule information whether the media asset is scheduled for transmission at another time and from the same or a different content source. In some implementations, control circuitry 304 may determine from the media asset schedule information whether the media asset is scheduled for transmission in a different format (e.g., HD or SD format) from the same or a different content source. In some implementations, the media asset information source may include a local or remote database of media asset access information. In particular, control circuitry 304 may determine from the media asset access information whether the media asset is available from another content source (e.g., an on-demand content source).

In some embodiments, in response to identifying another instance of the media asset, control circuitry 304 may transmit information associated with one or both instances of the media asset to PMU 320. For example, control circuitry 304 may transmit the scheduled transmission time of one or both instances of the media asset, the format (e.g., HD or SD) of one or both instances of the media asset, the content source or provider of one or both instances of the media asset, and/or any other suitable information. Control circuitry 304 may instruct PMU 320 to compute a power consumption cost associated with each instance of the media asset. In some implementations, the power consumption cost may be included with metadata associated with each instance of the media asset. In such circumstances, PMU 320 may receive the power consumption cost associated with each instance.

PMU 320 may cross-reference the information associated with each media asset instance with a power consumption cost database 600 to retrieve a power consumption cost associated with recording each instance of the media asset. For example, PMU 320 may determine a utility entity associated with the user equipment device 300 on which the recording will be performed. PMU 320 may select a power consumption cost database 600 corresponding to the determined utility entity.

In some embodiments, PMU 320 may retrieve a time during which the first media asset instance (e.g., the media asset instance requested by the user) is scheduled for transmission from a content source. PMU 320 may cross-reference the retrieved time with the selected database 600 to determine an average cost of power consumption during that time. For example, when the media asset is scheduled for transmission between 7:30 PM-8:30 PM, PMU 320 may determine that the cost of consuming power between 7:30-8 PM is $0.31 per kWh and that the cost of consuming power between 8-8:30 PM is $0.40 per kWh. Accordingly, PMU 320 may determine that the average cost of power consumption during the transmission time of the first media asset instance is $0.355 per kWh. Similarly, PMU 320 may retrieve a time during which the second media asset instance (e.g., the other media asset instance identified by control circuitry 304 during the search) is scheduled for transmission from a same or different content source. PMU 320 may cross-reference the retrieved time with the selected database 600 to determine an average cost of power consumption during that time (e.g., the time between 2 AM-3 AM). For example, when the media asset is scheduled for transmission between 2 AM-3 AM, PMU 320 may determine that the cost of consuming power is $0.12 per kWh. Accordingly, PMU 320 may determine that the average cost of power consumption during the transmission time of the second media asset instance is $0.12 per kWh.

In some embodiments, PMU 320 may retrieve a time during which the first media asset instance (e.g., the media asset instance requested by the user) is scheduled for transmission from a content source. PMU 320 may cross-reference the retrieved time with the selected database 600 to determine whether the cost of power consumption during that time is high, medium or low (i.e., without analyzing a specific monetary value). For example, when the media asset is scheduled for transmission between 7:30 PM-8:30 PM, PMU 320 may determine that the cost of consuming power during that time is medium. Similarly, PMU 320 may retrieve a time during which the second media asset instance (e.g., the other media asset instance identified by control circuitry 304 during the search) is scheduled for transmission from a same or different content source. PMU 320 may cross-reference the retrieved time with the selected database 600 to determine whether the cost of power consumption during the retrieved time is high, medium or low (i.e., without analyzing a specific monetary value). For example, when the media asset is scheduled for transmission between 2 AM-3 AM, PMU 320 may determine that the cost of consuming power during that time is low.

In some implementations, PMU 320 may retrieve from the selected power consumption cost database a value that represents the power consumed by recording resources of user equipment device 300 for recording the first instance of the media asset (e.g., how much power is consumed by recording the media asset for one hour—the time between 7:30 PM-8:30 PM). PMU 320 may combine (e.g., multiply) the retrieved power consumed during the recording of the first instance by the cost for consuming that power to determine the total power consumption cost associated with recording the first instance. PMU 320 may perform a similar computation to determine the total power consumption cost associated with recording the second instance.

In some embodiments, PMU 320 may retrieve a format (e.g., HD or SD) of the first media asset instance (e.g., the media asset instance requested by the user). PMU 320 may cross-reference the retrieved format with the selected database 600 to determine an average cost of power consumption for recording the first instance of the media asset in the retrieved format. For example, when the media asset instance format is high definition (e.g., HD), PMU 320 may determine that the amount of power consumed for recording the HD format is 0.0005 kW. Similarly, PMU 320 may retrieve a format (e.g., HD or SD) of the second media asset instance (e.g., the media asset instance requested by the user). PMU 320 may cross-reference the retrieved format with the selected database 600 to determine an average cost of power consumption for recording the second instance of the media asset in the retrieved format. For example, when the media asset instance format is standard definition (e.g., SD), PMU 320 may determine that the amount of power consumed for recording the HD format is 0.0003 kW. PMU 320 may determine whether the transmission times of the two instances are different. If PMU 320 determines that the transmission times are different, PMU 320 may retrieve the average cost for power consumption during the transmission time of each media asset instance. PMU 320 may combine the average cost for power consumption retrieved for each instance with the power consumed for recording each instance. PMU 320 may determine based on the combination a total power consumption cost for recording each instance of the media asset in the different formats. If PMU 320 determines that the transmission times are the same, PMU 320 may retrieve the average cost for power consumption during the transmission time of the media assets and may combine the average cost for power consumption with the power consumed for recording each instance. PMU 320 may determine based on the combination a total power consumption cost for recording each instance of the media asset in the different formats.

In some embodiments, other differences in specification of the first and second media asset instances (e.g., run-length, processing requirements) that cause recording the instances to have different power consumption costs may be considered in addition to or instead of the media formats. The functionality of selecting an instance for recording to reduce the total power consumption cost may be performed with respect to the different specifications of the media assets as that discussed with respect to the media assets having different formats. For example, in some implementations, the first instance may require additional local processing (e.g., splicing) to remove commercials when it is recorded/accessed whereas the second instance may not require the additional processing to remove the commercials when it is recorded/accessed. Accordingly, PMU 320 may determine that the cost associated with recording the first instance may be higher than the cost associated with recording the second instance.

In some embodiments, PMU 320 may compare the power consumption associated with recording the first instance of the media asset with the second instance of the media asset. For example, PMU 320 may compare the actual monetary value or power consumption value associated with each instance of the media asset to determine which instance is associated with a lower power consumption cost value. In some implementations, PMU 320 may compare the relative value (e.g., high, medium, low) associated with each instance of the media asset to determine which instance is associated with a lower power consumption cost value. For example, if the first instance is associated with a medium power consumption value and the second instance is associated with a low power consumption value, PMU 320 may determine that the second instance is associated with a lower power consumption value. PMU 320 may transmit a communication indicating which of the recording of the first and second media asset instances will consume less power or is associated with a lower cost for power consumption. The communication may indicate how much power is associated with recording each instance of the media asset and/or the power consumption cost associated with recording each media asset instance.

In some embodiments, in response to receiving the communication from PMU 320, control circuitry 304 may generate prompt 510 (FIG. 5) for display. In particular, based on the communication received from PMU 320, control circuitry 304 may determine that a given media asset instance (e.g., “The Simpsons” episode 27), selected for recording, may have another instance that can be recorded at a lower cost (e.g., will consume less power or will have a lower power consumption cost). Based on this determination, control circuitry 304 may display prompt 510 with a message 520 indicating that the given media asset that the user scheduled for recording can be recorded at a lower cost (monetary value or power).

Prompt 510 may include a keep scheduled recording option 530 and a record at a lower cost option 540. Option 530 may include a message or indication 532 as to the cost (monetary value or power consumption amount) of recording the previously selected instance (i.e., the originally scheduled instance of the media asset). For example, message or indication 532 may indicate that recording the media asset “The Simpsons” on Tuesday at 7 PM will have an energy consumption cost of $1.80. Similarly, option 540 may include a message or indication 542 as to the cost (monetary value or power consumption amount) of recording the other instance of the media asset that has not yet been scheduled for recording. For example, message or indication 542 may indicate that recording the media asset “The Simpsons” on Thursday at 2 AM will have an energy consumption cost of $0.75.

In response to receiving a user selection of option 530, control circuitry 304 may not modify the previously scheduled recording of the media asset. Accordingly, selection of option 530 will cause control circuitry 304 to record the media asset at the previously scheduled time (e.g., Tuesday at 7 PM). In response to receiving a user selection of option 540, control circuitry 304 may unscheduled the previously selected media asset from being recorded at the previously selected time (e.g., Tuesday at 7 PM) and may schedule for recording the other instance of the media asset instead (e.g., the instance on Thursday at 2 AM). Specifically, control circuitry 304 may modify the recording parameters of the selected instance of the media asset to record the other instance of the media asset instead. In some implementations, the other instance may be received from the same content source as the previously scheduled instance. In such circumstances, control circuitry 304 may only modify the time at which the recording will take place in the recording parameters. In some implementations, the other instance may be received from a different content source as the previously scheduled instance. In such circumstances, control circuitry 304 may modify the time at which the recording will take place in the recording parameters as well as the content source from which the instance of the media asset will be received.

In some embodiments, control circuitry 304 may automatically record the other instance of the media asset (e.g., the second instance) instead of the previously scheduled instance of the media asset (e.g., the first instance) responsive to the communication received from PMU 320. For example, control circuitry 304 may retrieve a power consumption priority value assigned to the first instance. In response to determining that the priority value that is assigned is low, control circuitry 304 may automatically record the second instance instead of the first instance. In response to determining that the priority value that is assigned is high, control circuitry 304 may maintain the scheduled recording of the first instance. In such implementations, prompt 510 may not be displayed when the communication from PMU 320 indicates that another instance of the media asset may be recorded at a lower cost.

In some embodiments, a user may select always record at a lower cost option 550 from prompt 510. In response to receiving the user selection of option 550, control circuitry 304 may store the user request in a memory. When control circuitry 304 receives the communication from PMU 320, control circuitry 304 may determine whether the memory includes the storage option to always record at a lower cost. In response to determining that the storage option to always record at a lower cost is set or was selected by the user, control circuitry 304 may automatically record the second instance instead of the first instance. The user selection of option 550 may be a global setting that applies to any media asset that is determined to have another instance that can be recorded at a lower cost. In order to undo the selection of option 550, the user may navigate to a power settings screen and de-select the option to always record the media assets at a lower cost. In such implementations, prompt 510 may not be displayed when the communication from PMU 320 indicates that another instance of the media asset may be recorded at a lower cost.

In some implementations, the global option to always record at the lowest cost may be set by the user locally or from a remote location (e.g., using a mobile device). In some embodiments, the global option to always record at the lowest cost may be set automatically when the device is switched to operate in a low power mode (e.g., by the user). In some embodiments, control circuitry 304 may receive a signal (e.g., indicating an emergency service announcement indicating the need to conserve power) from a remote location (e.g., via a broadcast transmission or directly from the remote location). In response to receiving the signal, control circuitry 304 may automatically set the global option to always record at the lowest cost.

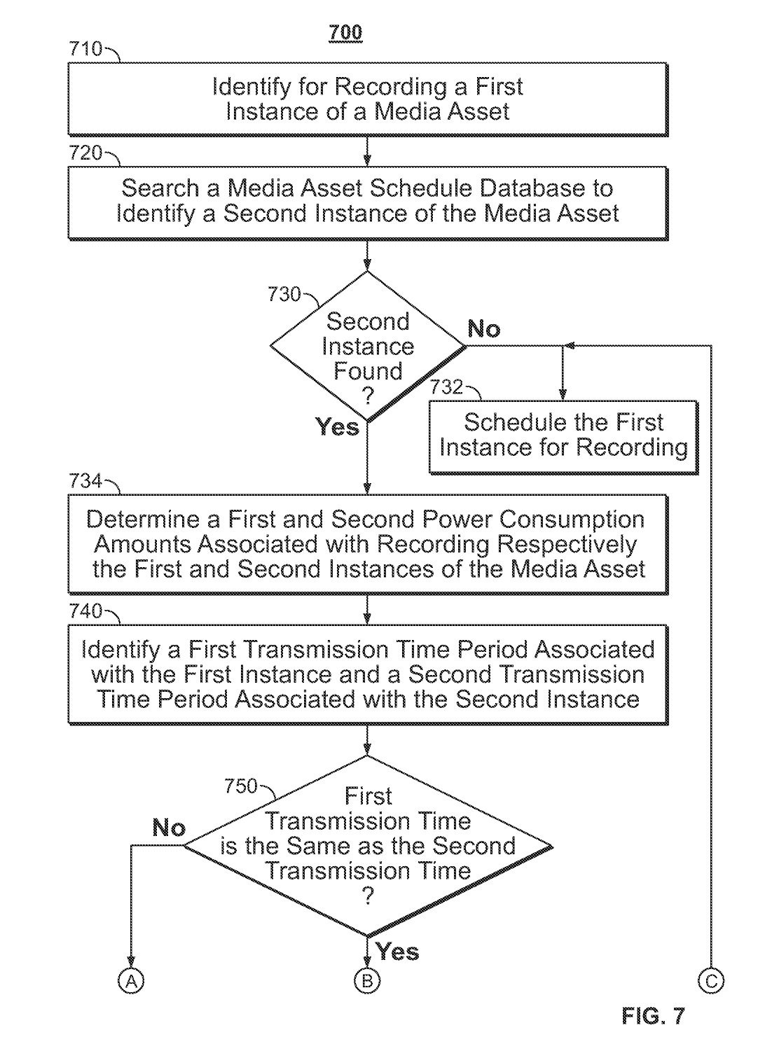

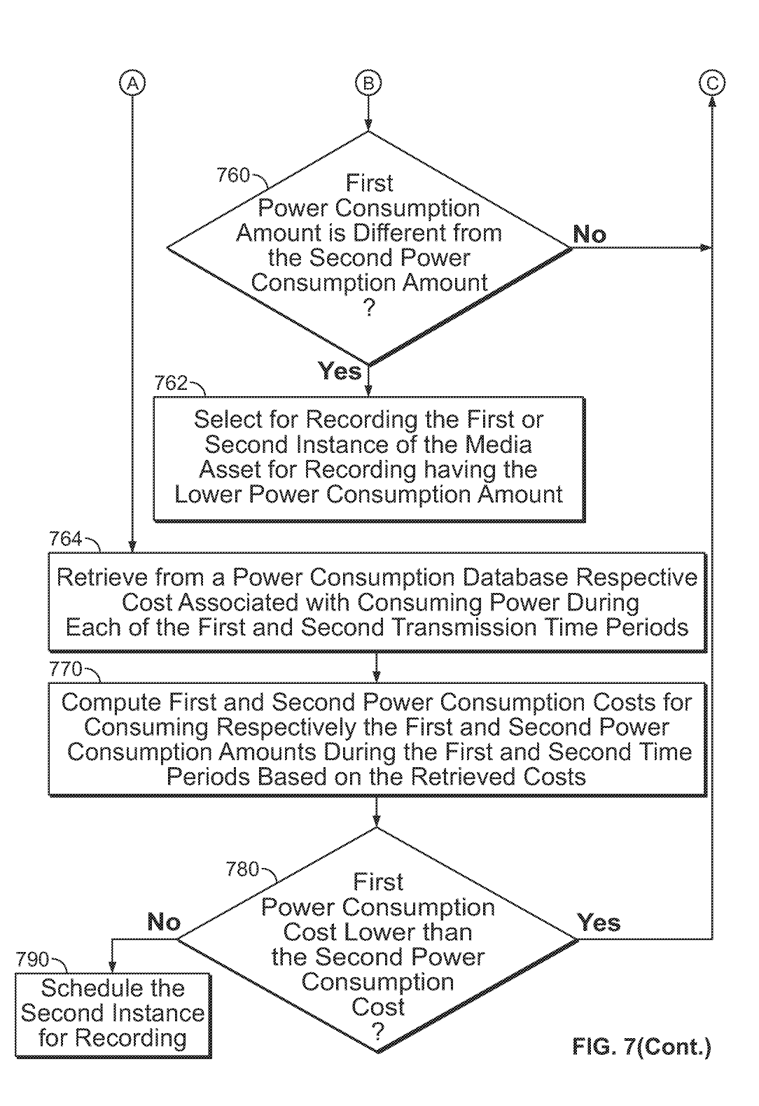

FIG. 7 is a flow diagram 700 of the illustrative steps involved in performing cost-efficient media asset recordings in accordance with some embodiments of the disclosure. At step 710, a first instance of a media asset is identified for recording. For example, control circuitry 304 may automatically select a media asset for recording based on a user profile and/or based on the media asset being part of a series that the user has requested to be recorded. In some implementations, control circuitry 304 may receive a user input (e.g., via selection of a program listing from a grid or overlay) that identifies the media asset and requests that the media asset be scheduled for recording.

At step 720, a media asset schedule database is searched to identify a second instance of the media asset. For example, control circuitry 304 may generate an SQL query that includes the title or unique identifier of the media asset instance and a request for alternate versions or transmission times of the media asset. The SQL query may be transmitted to a local or remote media asset schedule database which may return to control circuitry 304 the identifying information (e.g., title, content source, time, unique identifier) of another instance of the media asset if one is found.

At step 730, a determination is made as to whether the second instance of the media asset is found. When the second instance of the media asset is found, the process proceeds to step 734, otherwise the process proceeds to step 732. In some embodiments, control circuitry 304 may process priorities associated with each media asset instance. When the priority associated with the first media asset instance is higher than the second media asset instance priority, control circuitry 304 may proceed to step 732 instead of step 734 even though the second instance is found. When the priority associated with the first media asset instance is lower than the second media asset instance priority, control circuitry 304 may proceed to step 734.

At step 732, the first instance of the media asset is scheduled for recording or if the media asset was previously scheduled the recording parameters are not modified. For example, control circuitry 304 may instruct a recording device (e.g., DVR) or the media guidance application to generate recording parameters (e.g., title, transmission time, length, content source (channel)) and use the recording parameters to record or store the first media asset instance.

At step 734, first and second power consumption amounts associated with recording respectively the first and second instances of the media asset are determined. For example, control circuitry 304 may communicate with PMU 320 the identifying information of the first and second instances of the media asset. PMU 320 may identify the resources (e.g., recording device, HD/SD tuner and/or decoder circuit, etc.) that would be consumed by each of the first and second instances. PMU 320 may cross-reference a power consumption database associated with the identified resources and accumulate the amount of power that would be consumed during the interval when each media asset instance is recorded. Specifically, PMU 320 may determine that the first instance is a high definition version of the media asset and the second instance is a standard definition version of the media asset. Accordingly, PMU 320 may determine the resources needed to record the first version may include high definition tuning circuitry and decoding circuitry and that the resources needed to record the second version may include standard definition tuning circuitry and decoding circuitry. PMU 320 may process information stored in a database to determine the power consumption of the standard and high definition resources and may compute the power that would be consumed by the resources recording the first and second instances. In some implementations, PMU 320 may determine that the power consumed by recording the high definition version of the media asset (e.g., the first instance) may be higher than the power consumed by recording the standard definition version of the media asset (e.g., the second instance).

At step 740, a first transmission time period associated with the first instance and a second transmission time period associated with the second instance are identified. For example, control circuitry 304 may determine that the first instance is transmitted by a given content source between 7-8 PM and the second instance is transmitted by the same or different content source between 4-5 AM.

At step 750, a determination is made as to whether the first transmission time is the same as the second transmission time. When the first transmission time is determined to be the same as the second transmission time, the process proceeds to step 760, otherwise the process proceeds to step 764.

At step 760, a determination is made as to whether the first power consumption amount is different from the second power consumption amount. When the first power consumption amount is determined to be different from the second power consumption amount, the process proceeds to step 762, otherwise the process proceeds to step 732. For example, control circuitry 304 may receive from PMU 320 the respective power consumption amounts of each of the first and second instances of the media asset and compare the values of the first and second power consumption amounts with each other to determine whether they are the same or different.

At step 762, the first or second instance of the media asset having lower power consumption amount is selected for recording. For example, when the comparison made by control circuitry 304 indicates that recording the first instance will consume less power than recording the second instance, control circuitry 304 may maintain the scheduled recording of the first instance or schedule the first instance for recording. Alternatively, when the comparison made by control circuitry 304 indicates that recording the second instance will consume less power than recording the first instance, control circuitry 304 may schedule the second instance for recording.

At step 764, a respective cost associated with consuming power during each of the first and second transmission time periods is retrieved from a power consumption database. For example, PMU 320 may cross-reference a power consumption cost database 600 (e.g., a database listing time periods and their respective monetary values for consuming power, such as price per kWh) to determine the average cost (e.g., in monetary value) for consuming power when recording each media asset instance (FIG. 6).

At step 770, first and second power consumption costs for consuming respectively the first and second power consumption amounts during the first and second time periods are computed based on the retrieved costs. PMU 320 may determine the power consumption amount for each instance based on the resources identified as being needed to record each instance. PMU 320 may retrieve the cost for consuming power during the transmission time period of each instance and combine that retrieved value with each respective power consumption amount of each instance. PMU 320 may return to control circuitry 304 the cost associated with consuming power for recording the first instance and the cost associated with consuming power for recording the second instance of the media asset.

At step 780, a determination is made as to whether the first power consumption cost is lower than the second power consumption cost. When the first power consumption cost is determined to be lower than the second power consumption cost, the process proceeds to step 732, otherwise the process proceeds to step 790.

At step 790, the second instance of the media asset is scheduled for recording. For example, control circuitry 304 may instruct a recording device (e.g., DVR) or the media guidance application to generate recording parameters (e.g., title, transmission time, length, content source (channel)) and use the recording parameters to record or store the second instance of the media asset instead of the first instance of the media asset. Specifically, control circuitry 304 may un-schedule or delete the recording parameters associated with recording the first media asset instance to prevent the first media asset instance from being recorded and replace the recording of the first media asset instance with recording the second media asset instance.

It should be understood, that the above steps of the flow diagrams of FIG. 7 may be executed or performed in any order or sequence not limited to the order and sequence shown and described in the figure. Also, some of the above steps of the flow diagram of FIG. 7 may be executed or performed substantially simultaneously where appropriate or in parallel to reduce latency and processing times.

The above-described embodiments of the present disclosure are presented for purposes of illustration and not of limitation, and the present disclosure is limited only by the claims which follow.

1. A method for performing cost efficient media asset recording on a user equipment device, the method comprising:
identifying for recording a first instance of a media asset;
searching a media asset schedule database to identify a second instance of the media asset;
determining, based on cost of power consumption information, whether recording the first instance of the media asset will cost less than recording the second instance of the media asset; and
selecting either the first instance of the media asset or the second instance of the media asset for recording based on the determining.

2. The method of claim 1, wherein:
the first instance of the media asset is scheduled for transmission during a first time period and the second instance of the media asset is scheduled for transmission during a second time period;
further comprising cross-referencing the first time period and the second time period with a power consumption cost database to retrieve from storage a first power consumption cost associated with the first time period and a second power consumption cost associated with the second time period; and
the cost of power consumption information includes the first and second power consumption costs.

3. The method of claim 1, wherein the first instance of the media asset is a higher definition version of the media asset than the second instance, wherein the cost of power consumption information indicates that recording the higher definition version of the media asset consumes more power than recording a lower definition version of the media asset, and wherein the determining determines that recording the first instance of the media asset will not cost less than recording the second instance of the media asset based on the definition of the media asset.

4. The method of claim 1, wherein content of the second instance of the media asset is identical to content of the first instance of the media asset.

5. The method of claim 1 further comprising:
transmitting to a server an identifier of a utility entity associated with the user equipment device;
receiving from the server the cost of power consumption information associated with the utility entity based on the identifier.

6. The method of claim 1 further comprising:
receiving user input indicating power consumption cost associated with different time periods;
generating the cost of power consumption information based on the power consumption costs indicated by the user.

7. The method of claim 1 further comprising scheduling the second instance of the media asset for recording instead of the first instance of the media asset in response to determining that recording the second instance of the media asset will cost less than recording the first instance of the media asset.

8. The method of claim 1 further comprising switching the user equipment device from a first power mode to a second power mode to record the selected first instance of the media asset or the second instance of the media asset, wherein the second power mode consumes more power than the first power mode.

9. The method of claim 1 further comprising generating for display an option to perform power efficient recording, wherein selection of either the first instance of the media asset or the second instance of the media asset for recording is performed in response to receiving a user selection of the option.

10. The method of claim 1, wherein identifying for recording the first instance comprises at least one of receiving a user request to record the first instance of the media asset and automatically selecting the first instance of the media asset for recording.

11. A system for performing cost efficient media asset recording on a user equipment device, the system comprising:
control circuitry configured to:
identify for recording a first instance of a media asset;
search a media asset schedule database to identify a second instance of the media asset;
determine, based on cost of power consumption information, whether recording the first instance of the media asset will cost less than recording the second instance of the media asset; and
select either the first instance of the media asset or the second instance of the media asset for recording based on the determining.

12. The system of claim 11, wherein:
the first instance of the media asset is scheduled for transmission during a first time period and the second instance of the media asset is scheduled for transmission during a second time period;
the control circuitry is further configured to cross-reference the first time period and the second time period with a power consumption cost database to retrieve from storage a first power consumption cost associated with the first time period and a second power consumption cost associated with the second time period; and
the cost of power consumption information includes the first and second power consumption costs.

13. The system of claim 11, wherein the first instance of the media asset is a higher definition version of the media asset than the second instance, wherein the cost of power consumption information indicates that recording the higher definition version of the media asset consumes more power than recording a lower definition version of the media asset, and wherein the determining determines that recording the first instance of the media asset will not cost less than recording the second instance of the media asset based on the definition of the media asset.

14. The system of claim 11, wherein content of the second instance of the media asset is identical to content of the first instance of the media asset.

15. The system of claim 11, wherein the control circuitry is further configured to:
transmit to a server an identifier of a utility entity associated with the user equipment device;
receive from the server the cost of power consumption information associated with the utility entity based on the identifier.

16. The system of claim 11, wherein the control circuitry is further configured to:
receive user input indicating power consumption cost associated with different time periods;
generate the cost of power consumption information based on the power consumption costs indicated by the user.

17. The system of claim 11, wherein the control circuitry is further configured to schedule the second instance of the media asset for recording instead of the first instance of the media asset in response to determining that recording the second instance of the media asset will cost less than recording the first instance of the media asset.

18. The system of claim 11, wherein the control circuitry is further configured to switch the user equipment device from a first power mode to a second power mode to record the selected first instance of the media asset or the second instance of the media asset, wherein the second power mode consumes more power than the first power mode.

19. The system of claim 11, wherein the control circuitry is further configured to generate for display an option to perform power efficient recording, wherein selection of either the first instance of the media asset or the second instance of the media asset for recording is performed in response to receiving a user selection of the option.

20. The system of claim 11, wherein the control circuitry is further configured to perform at least one of receiving a user request to record the first instance of the media asset and automatically selecting the first instance of the media asset for recording.

21-40. (canceled)
